(19) United States
(12) Patent Application Publication
(10) Pub. No.: US 2008/0300029 A1
(43) Pub. Date: Dec. 4, 2008

(54) INDUCTIVE FLEXIBLE CIRCUIT FOR COMMUNICATION DEVICE

(75) Inventors: Hongwei Liu, South Elgin, IL (US); Adrian Napoles, Lake Villa, IL (US); Guangli Yang, Waukegan, IL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/756,317

(22) Filed: May 31, 2007

(51) Int. Cl. H04M 1/00

(52) U.S. Cl. 455/575.3; 455/575.7

(57) ABSTRACT

A communication device (100) is described herein. The device can include a first substrate (135) that can contribute to an electrical length of the communication device, a second substrate (140) that can contribute to the electrical length of the communication device and an inductive flexible circuit (145) that can be coupled to the first substrate and the second substrate. The inductive flexible circuit can transfer signals between the first and second substrates and can lengthen a first portion of the electrical length (E_{L1}) of the communication device to a fractional wavelength of interest.

### BACKGROUND OF THE INVENTION

1. Field of the Invention

The claimed subject matter concerns flexible circuits for communication devices and more particularly, flexible circuits adjusting the electrical length of such devices.

2. Description of the Related Art

Customers of manufacturers of mobile devices are demanding that the devices include an internal antenna and operate over multiple communication bands. Mobile devices that include a flip portion coupled to a base portion through a hinge, commonly referred to as “clamshell” units, have become quite popular, too. As such, device manufacturers have implemented internal antenna elements near the bottom of the clamshell devices. Sometimes, however, the electrical length of the clamshell device results in a less-than-optimal multi-band performance when this antenna configuration is used. Thus, there is a need to adjust the electrical length of a mobile device, while simultaneously improving radiation performance.

### SUMMARY OF THE INVENTION

A communication device is described herein. The communication device can include a first substrate that can contribute to an electrical length of the communication device, a second substrate that can contribute to the electrical length of the communication device and an inductive flexible circuit that can be coupled to the first substrate and the second substrate. The inductive flexible circuit can transfer signals between the first and second substrates and can lengthen a first portion of the electrical length of the communication device to a fractional wavelength of interest.

In one arrangement, the device can further include an internal antenna that can be coupled to the second substrate. As an example, the internal antenna can be a folded J antenna. The device can also have a feed point in which the internal antenna can be coupled to the second substrate through the feed point. As another example, the internal antenna can be a quarter-wavelength antenna that can make up a second portion of the electrical length of the communication device.

In another arrangement, the first substrate, the second substrate and the inductive flexible circuit may combine to make up the first portion of the electrical length of the communication device, and the fractional wavelength of interest can be a three-quarter wavelength.

The first substrate, the second substrate and the inductive flexible circuit may be defined by a physical length. In addition, the inductive flexible circuit can be a distributed model that can increase the physical length. As an example, at least part of the distributed model inductive flexible circuit can have a helical configuration.

In another configuration, the inductive flexible circuit can be a lumped model that can include a lumped inductor. The lumped inductor can have an inductor value that can be selected to increase the first portion of the electrical length. Further, the lumped model does not substantially increase the physical length. As an example, the inductive flexible circuit also may include two substantially planar portions, and the lumped inductor can be positioned between the two planar portions. Alternatively, the inductive flexible circuit may include a substantially planar portion and two lumped inductors, one lumped inductor being positioned at a first end of the planar portion and the other lumped inductor being positioned at a second end of the planar portion. The lumped model may be useful when spatial constraints in the hinge prevent the use of a distributed model inductive flexible circuit.

In one embodiment, the communication device may be a multi-band wireless device, and the fractional wavelength of interest may result in improved signal reception at frequencies approximately between 800 MHz and 1,000 MHz. For example, the communication device may be a quad-band device. In another embodiment, the first substrate can be a printed circuit board contained in a flip portion of the communication device, and the second substrate can be a printed circuit board contained in a base portion of the communication device. The device may also include a hinge that can rotatably couple the flip portion to the base portion, and the inductive flexible circuit can be contained within the hinge.

### BRIEF DESCRIPTION OF THE DRAWINGS

Features that are believed to be novel are set forth with particularity in the appended claims. The claimed subject matter may best be understood by reference to the following description, taken in conjunction with the accompanying drawings, in the several figures of which like reference numerals identify like elements, and in which:

FIG. 1 illustrates an example of a communication device and an example of a block diagram of that device;

FIG. 2 illustrates an example of an electrical representation of the communication device of FIG. 1;

FIG. 3 illustrates an example of a distributed model inductive flexible circuit;

FIG. 4 illustrates an example of a lumped model inductive flexible circuit;

FIG. 5 illustrates another example of a lumped model inductive flexible circuit;

FIG. 6 illustrates an example of a hybrid model inductive flexible circuit; and

FIG. 7 illustrates a decibel v. frequency graph that shows improvement in signal reception in certain frequency bands.

### DETAILED DESCRIPTION

As required, detailed embodiments of the claimed subject matter are disclosed herein; however, it is to be understood that the disclosed embodiments are merely exemplary and can be embodied in various forms. Therefore, specific structural and functional details disclosed herein are not to be interpreted as limiting, but merely as a basis for the claims and as a representative basis for teaching one skilled in the art to variously employ the claimed subject matter in virtually any appropriately detailed structure. Further, the terms and phrases used herein are not intended to be limiting but rather to provide an understandable description.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled” as used herein, are defined as connected, although not necessarily directly, and not necessarily mechanically. The term “communication device” can be any component or group of components that are capable of receiving and/or transmitting communications signals. A “substrate” can be defined as any supporting material on which a circuit is formed or fabricated. Also, the term “electrical length” can be defined as a length of a medium expressed in terms of a multiple or a sub-multiple of the wavelength of a signal propagating within the medium. An “internal antenna” can be defined as an antenna and its supporting structure that is enclosed within a housing.

A communication device is described herein. The device can include a first substrate that can contribute to an electrical length of the communication device, a second substrate that can contribute to the electrical length of the communication device and an inductive flexible circuit that can be coupled to the first substrate and the second substrate. The inductive flexible circuit can transfer signals between the first and second substrates and can lengthen a first portion of the electrical length of the communication device to a fractional wavelength of interest. By lengthening the electrical length in this manner, an improvement in performance can be attained in certain frequencies, such as lower frequency bands for a quad-band device. Moreover, this improvement can be accomplished without increasing the overall external physical dimensions of the communication device.

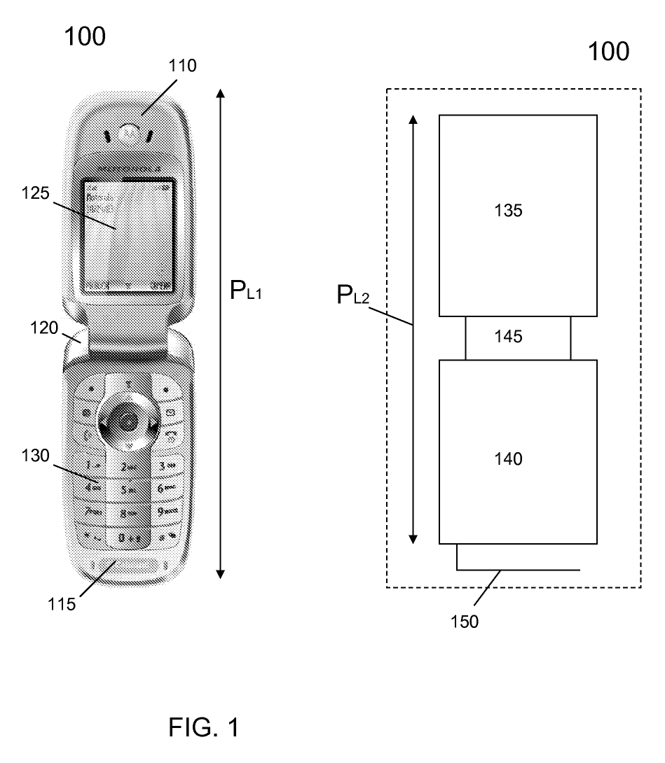

Referring to FIG. 1, an example of a communication device 100 is shown. In this example, the device 100 can be a wireless, multi-band communication device that has a clamshell form factor. In one particular example, the device 100 can be a quad-band wireless mobile unit, capable of operating in the following frequency bands: (1) 824 MHz-894 MHz for Advanced Mobile Phone Service (AMPS); (2) 880 MHz-960 MHz for Extended Global System for Mobile Communications (EGSM); (3) 1,710 MHz-1,880 MHz for Digital Cellular System (DCS); and (4) 1,850 MHz-1,990 MHz for Personal Communications Services (PCS). Of course, the device 100 is not limited in any way to this example, as it may operate in any other suitable bands, including a single band.

In this example, the communication device 100 can include a flip portion 110, a base portion 115 and a hinge 120 that rotatably couples the flip portion 110 to the base portion 115. As is known in the art, the flip portion 110 typically includes a display 125, while the base portion 115 normally supports a keypad 130. In one arrangement, the communication device 100 can include a first physical length P_{L1}, which can represent the overall length of the device 100 when the device 100 is in an open position, as pictured here.

Also shown in FIG. 1 is an example of a block diagram of the device 100. In this example, the device 100 can include a first substrate 135, a second substrate 140 and an inductive flexible circuit 145 (or inductive flex 145), which can be coupled to both the first substrate 135 and the second substrate 140. The block representation of the inductive flex 145 is not meant to limit the shape or configuration of the inductive flex 145 in any way. An “inductive flexible circuit” can be defined as any circuit that can transfer electrical signals between two or more components and that can affect the electrical length of a communication device. There are several suitable configurations for the inductive flex 145 that will be presented below. In one arrangement, the inductive flex 145 can be contained within the hinge 120. Moreover, the first substrate 135 can be contained within the flip portion 110, and the second substrate 140 can be contained within the base portion 115.

The device 100 may also include an internal antenna 150. As an example, the internal antenna 150 can be a folded J antenna. It must be understood, however, that the device 100 is not limited to this particular arrangement, as other suitable antenna configurations may be employed, including an external antenna element. In one arrangement, the first substrate 135 and the second substrate 140 can be printed circuit boards (PCB), and the inductive flex 145 can be coupled to ground planes of both the first substrate and second substrate 140. The first substrate 135, the second substrate 140 and the inductive flex 145 can be defined by a second physical length P_{L2}, which can represent the actual total linear length of these components.

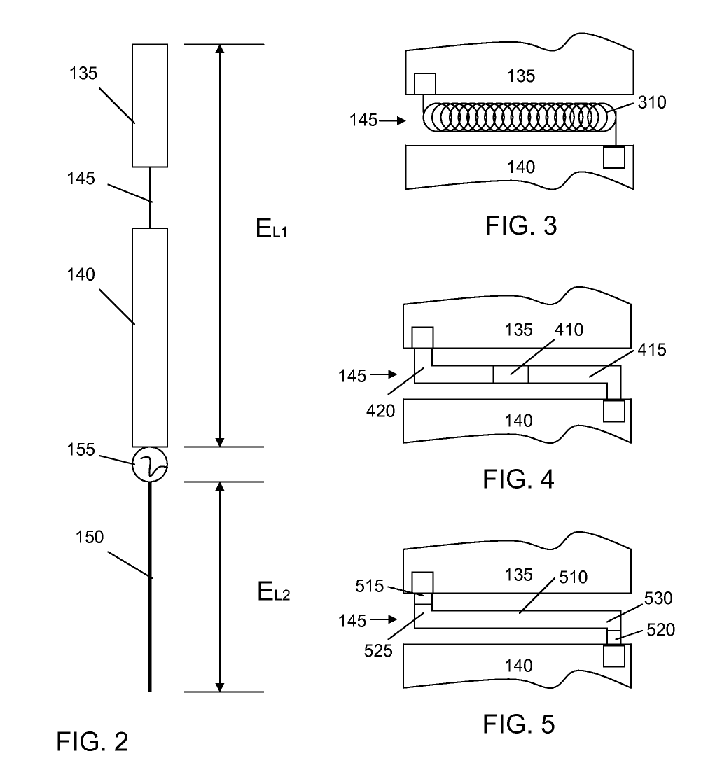

Referring to FIG. 2, an example of an electrical representation of the device 100 is shown. Electrical representations are included here for the first substrate 135, the second substrate 140, the inductive flex 145 and the internal antenna 150. Also shown is an electrical representation of a feed point 155, which can be coupled to the second substrate 140 and the internal antenna 150. Although only one feed point 155 is illustrated here, it must be noted that the device 100 may include numerous feed points 155, which can be positioned in any suitable structure of the device 100.

The first substrate 135, the second substrate 140 and the inductive flex 145 can all contribute to a first electrical length E_{L1} of the device 100, while the internal antenna 150 can contribute to the electrical length of the device 100 through a second electrical length E_{L2}. As an example, the second electrical length E_{L2} can be a quarter-wavelength, although other suitable wavelengths may be used.

As another example, the inductive flex 145 can lengthen the first electrical length E_{L1} to a fractional wavelength of interest. A “fractional wavelength of interest” can mean any multiple or sub-multiple of a wavelength that produces an optimal or desired radiation performance. As an example, the inductive flex 145 can lengthen the first electrical length E_{L1} to a three-quarter wavelength. It is understood, however, that the fractional wavelength of interest is not limited to a three-quarter wavelength, as the first electrical length E_{L1} can be lengthened to other suitable wavelengths, depending on the desired performance characteristics. In addition, the lengthening of the electrical length E_{L1} does not affect the first physical length P_{L1} (see FIG. 1), the overall physical length of the communication device 100.

Referring to FIG. 3, a first example of an inductive flex 145 coupled to the first substrate 135 and the second substrate 140 is shown. In this example, the inductive flex 145 can be a distributed model that increases, in addition to the first electrical length E_{L1}, the second physical length P_{L2} (see FIG. 1). A “distributed model” can be defined as a configuration where an inductive flexible circuit increases both a physical length and an electrical length of a communication device. For example, at least part of the inductive flex 145 can have a physical lengthening unit 310, such as a helical configuration or a configuration having at least one curve, like that pictured here. The curves of the distributed model add to the linear distance of the inductive flex 145, thereby increasing the second physical length P_{L2}. Nevertheless, the distributed model does not affect the first physical length P_{L1} (see FIG. 1). Those of skill in the art will appreciate that other suitable designs can be employed here to serve as a distributed model. The distributed model may be useful where the hinge 120 has sufficient spacing to accept the increased volume of such a configuration.

Referring to FIG. 4, another example of an inductive flex 145 is shown. Here, the inductive flex 145 can be a lumped model that includes a lumped inductor 410 in which the lumped inductor has an inductor value that can be selected to increase, for example, the electrical length E_{L1} (see FIG. 2). A “lumped model” can be defined as a design that increases an electrical length of a communication device but does not substantially increase a physical length of the device. For example, a conventional flexible circuit, as is known in the art, is a substantially planar medium. As pictured, the inductive flex 145 can include two substantially planar portions 415, 420, and the lumped inductor 410 can be positioned between the two planar portions 415, 420. The lumped inductor 410 can be positioned at any suitable positioned between the planar portions 415, 420, and in fact, more than one lumped inductor 410 can be implemented in the inductive flex 145. Because the lumped inductor 410 is relatively straight, it generally does not add to the second physical length P_{L2}, in contrast to the distributed model.

Referring to FIG. 5, another example of a lumped model is shown. In this case, the inductive flex 145 can include a substantially planar portion 510 and two lumped inductors 515, 520. One lumped inductor 515 can be placed at a first end 525 of the planar portion 510, while the other lumped inductor 520 can be positioned at a second end 530 of the planar portion 510. The lumped inductor 515 can be grounded to the first substrate 135 (see FIG. 1), and the other lumped inductor 520 can be grounded to the second substrate 140. If desired, other lumped inductors can be implemented into the planar portion 510.

In either lumped model arrangement, the electrical length E_{L1} can be lengthened without affecting the second physical length P_{L2} (or the first physical length P_{L1}). The lumped model may be useful where spatial constraints in the hinge 120 prevent the implementation of a distributed model. As noted earlier, the distributed or lumped models can increase the first electrical length E_{L1} to a three-quarter wavelength, although it is not limited to such a value. The selection of a distributed or lumped model may affect which frequency bands see an improvement and to what extent, and these models may be chosen to accommodate desired radiation performances.

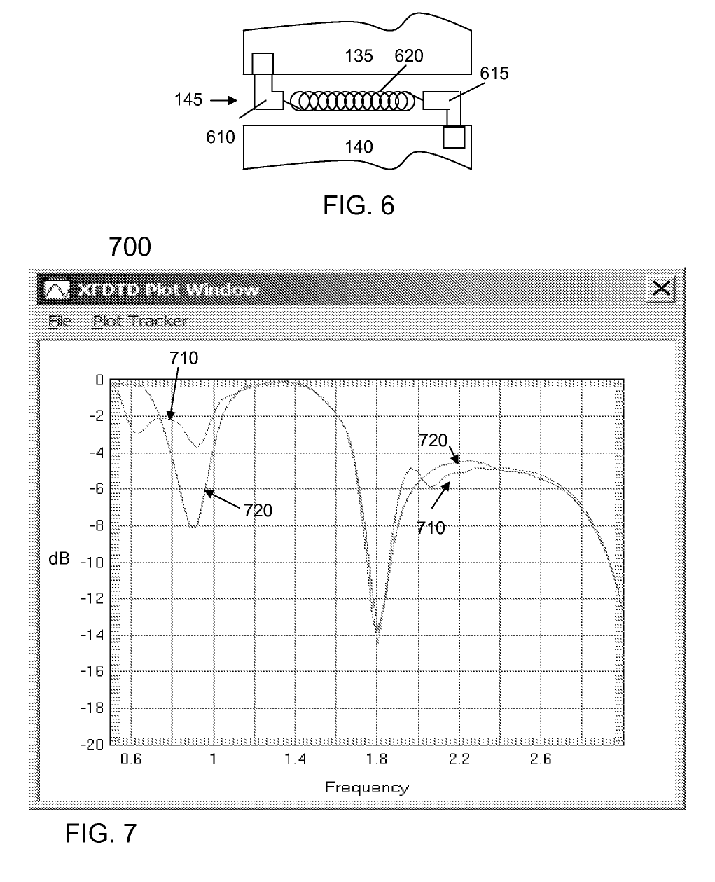

Referring to FIG. 6, yet another example of an inductive flex 145 is shown. In this example, the inductive flex 145 can be a hybrid model that includes elements of both distributed and lumped designs. A “hybrid model” can be defined as a design that increase an electrical length of a communication device but increases a physical length of the device less than a complete distributed model but more than a complete lumped model. For example, the inductive flex 145 can include a first lumped inductor 610 coupled to the first substrate 135 and a second lumped inductor 615 coupled to the second substrate 140. The inductive flex 145 may also include a physical lengthening unit 620 coupled to the first lumped inductor 610 and the second lumped inductor 615. This arrangement may be useful where the space available in the hinge 120 is greater than that provided for in the lumped models described above but less than what is allowed in the distributed model. In addition, the hybrid model may be selected based on desired operating characteristics, such as improvement in reception in a particular frequency band. In view of the physical lengthening unit 620, the hybrid model may increase the second physical length P_{L2} (see FIG. 1).

Referring to FIG. 7, a decibel v. frequency graph 700 reflecting how the inductive flex 145 improves operation of the communication device 100 is shown. Specifically, the graph 700 illustrates how a distributed model inductive flex 145 improves the operation of the device 100, although the operational enhancements can be achieved through the other models discussed above. The first graph 710 shows the performance of a multi-band communication device that uses a conventional flexible circuit. In particular, there is degradation in the lower frequency bands of this model. The second graph 720 demonstrates an example of the operation of the communication device 100 with the inductive flex 145. As pictured, there can be an improvement in signal reception in the frequencies that run from approximately 800 MHz to approximately 1,000 MHz, which can result in better performance in, for example, the AMPS and EGSM bands. It must be noted, however, that improvement in signal reception is not limited to these particular bands or frequencies. The improvement in these frequencies does not negatively affect operation in the higher bands, either.

While the various embodiments of the have been illustrated and described, it will be clear that the claimed subject matter is not so limited. Numerous modifications, changes, variations, substitutions and equivalents will occur to those skilled in the art without departing from the spirit and scope of the present invention as defined by the appended claims.

What is claimed is:

1. A communication device, comprising:
a first substrate that contributes to an electrical length of the communication device;
a second substrate that contributes to the electrical length of the communication device; and
an inductive flexible circuit that is coupled to the first substrate and the second substrate, wherein the inductive flexible circuit transfers signals between the first and second substrates and lengthens a first portion of the electrical length of the communication device to a fractional wavelength of interest.

2. The device according to claim 1, further comprising an internal antenna that is coupled to the second substrate.

3. The device according to claim 2, wherein the internal antenna is a folded J antenna.

4. The device according to claim 2, further comprising a feed point, wherein the internal antenna is coupled to the second substrate through the feed point.

5. The device according to claim 4, wherein the internal antenna is a quarter-wavelength antenna that makes up a second portion of the electrical length of the communication device.

6. The device according to claim 5, wherein the first substrate, the second substrate and the inductive flexible circuit combine to make up the first portion of the electrical length of the communication device, wherein the fractional wavelength of interest is a three-quarter wavelength.

7. The device according to claim 1, wherein the first substrate, the second substrate and the inductive flexible circuit are defined by a physical length.

8. The device according to claim 7, wherein the inductive flexible circuit is a distributed model that increases the physical length.

9. The device according to claim 8, wherein at least part of the inductive flexible circuit has a helical configuration.

10. The device according to claim 7, wherein the inductive flexible circuit is a lumped model that includes a lumped inductor, wherein the lumped inductor has an inductor value that is selected to increase the first portion of the electrical length.

11. The device according to claim 10, wherein the lumped model does not substantially increase the physical length.

12. The device according to claim 10, wherein the inductive flexible circuit also includes two substantially planar portions and the lumped inductor is positioned between the two planar portions.

13. The device according to claim 10, wherein the inductive flexible circuit includes a substantially planar portion and two lumped inductors, one lumped inductor being positioned at a first end of the planar portion and the other lumped inductor being positioned at a second end of the planar portion.

14. The device according to claim 1, wherein the inductive flexible circuit is a hybrid model that includes elements of both distributed and lumped models.

15. The device according to claim 1, wherein the communication device is a multi-band wireless device and the fractional wavelength of interest results in improved signal reception at frequencies approximately between 800 MHz and 1,000 MHz.

16. The device according to claim 1, wherein the first substrate is a printed circuit board contained in a flip portion of the communication device and the second substrate is a printed circuit board contained in a base portion of the communication device.

17. The device according to claim 16, further comprising a hinge that rotatably couples the flip portion to the base portion, and the inductive flexible circuit is contained within the hinge.

18. A multi-band wireless communication device having a flip portion, a base portion and a hinge that rotatably couples the flip portion to the base portion, comprising:
a first printed circuit board contained within the flip portion;
a second printed circuit board contained within the base portion; and
an inductive flexible circuit coupled to the first printed circuit board and the second printed circuit board, wherein the inductive flexible circuit resides within the hinge and lengthens at least a portion of an electrical length of the wireless device.

19. The wireless device according to claim 18, wherein the wireless device is a quad-band device and the lengthening of the portion of the electrical length improves the signal reception in at least one of the bands in which the quad-band device operates.

20. The wireless device according to claim 18, wherein the inductive flexible circuit is a distributed model that increases a physical length of the wireless device.

21. The wireless device according to claim 18, wherein the inductive flexible circuit is a lumped model that does not substantially increase a physical length of the wireless device, wherein the lumped model is employed when spatial constraints in the hinge prevent the use of a distributed model inductive flexible circuit.
